(19) United States
(12) Patent Application Publication
(10) Pub. No.: US 2018/0070540 A1
(43) Pub. Date: Mar. 15, 2018

(54) GRIPPING ARRANGEMENT

(71) Applicant: GRIPPLE LIMITED, Sheffield, South Yorkshire (GB)

(72) Inventor: John Butterworth, Sheffield, South Yorkshire (GB)

(21) Appl. No.: 15/561,657

(22) PCT Filed: Mar. 17, 2016
(86) PCT No.: PCT/GB2016/000052

§ 371 Date: Sep. 26, 2017

(30) Foreign Application Priority Data
Mar. 26, 2015 (GB) 1505217.8
Mar. 16, 2016 (GB) 1604446.3

(51) Int. Cl. A01G 17/06; E04H 17/08

(52) U.S. Cl. CPC A01G 17/06; A01G 2017/065; E04H 17/08

(57) ABSTRACT

A gripping arrangement (10) comprises a wound portion (12) disposable around a main support (100), and a holding formation (14, 16) for holding a force applying arrangement (22). A force applied to the holding formation (14, 16) in a first direction to extend the wound portion (12) in said first direction can effect a contracting movement on the wound portion (12) in a second direction transverse to the first direction.

This invention relates to gripping arrangements. This invention also relates to tension applying assemblies. More particularly, but not exclusively, this invention relates to tension applying assemblies and methods of using tension applying assemblies.

In vineyards, the vines can be supported by wires extending between support posts. The support posts are, in turn, supported by tendons extending from the post to the ground. The tendons are held in tension to prevent the wires from moving the support posts. A loop is formed in the tendon and disposed around the post. The tendon is then anc [symbol] ored to the ground and tensioned. However, the loop around the post has a tendency to slip down the post, thereby allowing the post to move.

According to one aspect of this invention, there is provided a gripping arrangement comprising a wound portion disposable around a main support, and a holding formation for holding a force applying arrangement, wherein a force applied to the holding formation in a first direction to extend the wound portion in said first direction effects a contracting movement on the wound portion in a second direction transverse to the first direction.

According to another aspect of this invention, there is provided a tension applying assembly for attaching to a main support, said assembly comprising a gripping arrangement and a force applying arrangement, the gripping arrangement comprising a wound portion disposable around a support and a holding formation for holding the force applying arrangement, wherein a force applied to the holding formation in a first direction to extend the wound portion in said first direction effects a contracting movement on the wound portion in a second direction transverse to the first direction.

According to another aspect of this invention, there is provided a method of using a tension applying assembly as described above, said method comprising disposing the gripping arrangement on a main support, arranging the force applying arrangement to extend around the main support, so that the force applying arrangement engages the holding formation, and securing the force applying arrangement to the ground, wherein the force applying arrangement can apply a force to the holding formation to cause the gripping arrangement to extend in a first direction lengthwise of the main support, and contract in a second direction transverse to the first direction to grip the main support.

Thus, a tension force applied by the force applying arrangement to the holding formation in said first direction causes the wound portion to contract in said second direction and tighten around the main support. The contraction of the wound portion may be a radially inward contraction.

The main support may comprise a support post, which may be a cylindrical post.

The force applying arrangement may comprise a flexible member, which may be an elongate flexible member. The force applying arrangement may comprise an elongate tendon. The elongate member may comprise a wire, wire rope, cable or the like. The force applying arrangement may comprise a stay.

The force applying arrangement may comprise a loop formation on the elongate element. In use, the loop formation may extend around the main support and may engage the holding formation.

The wound portion may comprise an elongate element. The wound portion may comprise a winding of greater than half a turn of the elongate element. In one embodiment, the wound portion may comprise a winding of at least one turn of the elongate element. The wound portion may comprise a winding of substantially one and a half turns of the elongate element.

The gripping arrangement may comprise first and second holding formations. The first holding formation may be provided at a first end of the wound portion. The second holding formation may be provided at a second opposite end of the wound portion.

The, or each, holding formation may comprise a hook. Where the securing arrangement comprises first and second holding formations, the first holding formation may comprise a first hook, and the second holding formation may comprise a second hook.

The force applying arrangement may include a loop formation to extend around the main support. The loop formation may engage the holding formation, whereby the force applying arrangement can apply a tension force to the holding formation in said first direction to cause the wound portion to contract as aforesaid and grip the main support.

The force applying arrangement may comprise a subsidiary support for supporting the main support. The force applying arrangement may comprise the elongate element and an anchor arrangement for anchoring the force applying arrangement to the ground. The anchor arrangement may be as described in published UK Patent Application No. GB2514004. The force applying arrangement may be tightened, thereby applying a force to the holding formation.

At least one embodiment of the invention will now be described by way of example only, with reference to the accompanying drawings, in which:

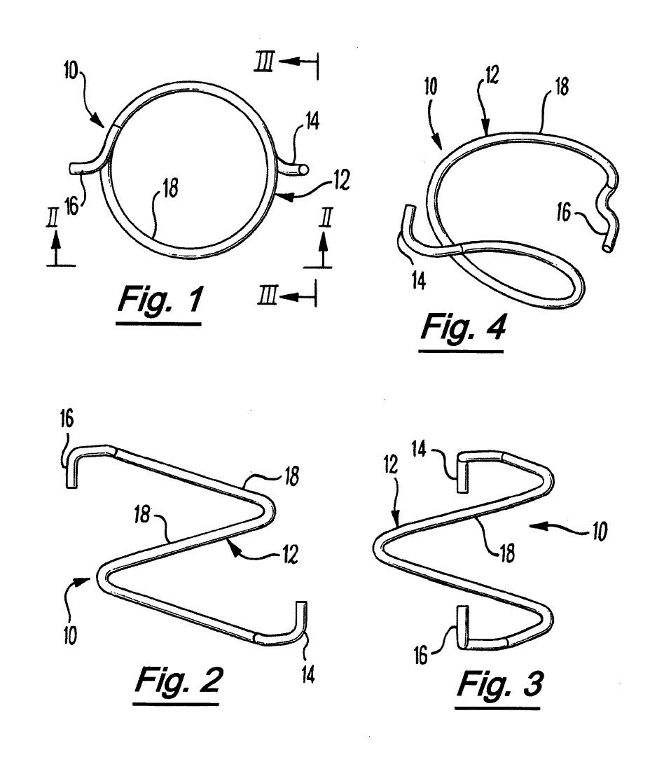

FIG. 1 is an end view of a gripping arrangement;

FIG. 2 is a view along the lines II-II in FIG. 1;

FIG. 3 is a view along the lines III-III in FIG. 1;

FIG. 4 is a perspective view of the gripping arrangement shown in FIG. 1;

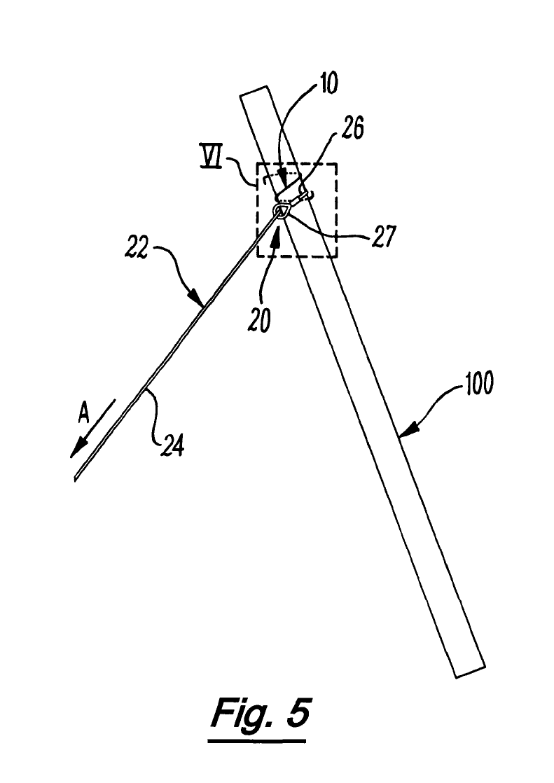

FIG. 5 shows a tension applying assembly comprising a force applying arrangement and a gripping arrangement in use on a main support;

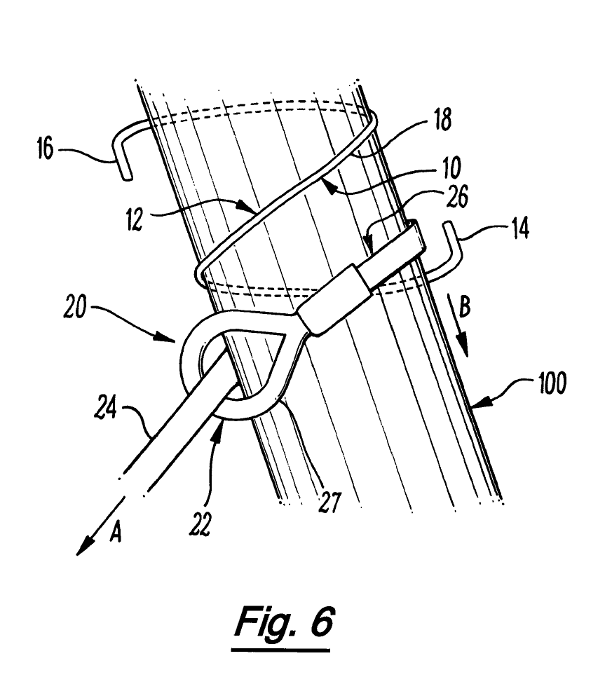

FIG. 6 is a close up of the region marked VI in FIG. 5;

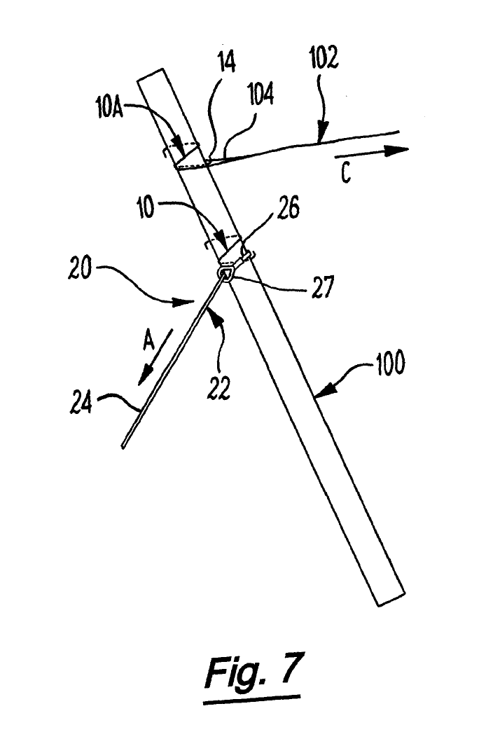

FIG. 7 shows the tension applying assembly and the main support shown in FIG. 5 with a further tension applying arrangement.

FIGS. 1 to 4 show a gripping arrangement 10 for gripping a main support such as a cylindrical support post 100 (see FIGS. 5 to 7). The gripping arrangement 10 comprises a wound portion 12 and a holding formation comprising first and second hook formations 14, 16.

The first and second hook formations 14, 16 are provided at respective first and second opposite ends of the wound portion 12. The wound portion 12 comprises an elongate element 18 and is formed of a winding of one and a half turns of the elongate element 18. As can be seen from FIG. 1, the end profile of the wound portion 12 is substantially circular.

The hook formations 14, 16 are arranged so that the gripping arrangement 10 can be used with either the first or the second hook formations 14, 16 at the lower end of the wound portion 12. In the drawings, the first hook formation 14 of each of the gripping arrangements 10 shown is disposed at the lower end of the wound portion 12.

A tension applying assembly 20 suitable for use in an agricultural environment, for example a vineyard, is shown in FIGS. 5 to 7. The tension applying assembly 20 is used to apply tension to the support post 100, which is provided at the end of a row of vines to support the cables on which the vines are grown. The tension applying assembly 20 comprises the gripping arrangement 10 and a force applying arrangement 22.

The force applying arrangement 22 comprises a flexible elongate tendon 24 and a ground anchor (not shown) at the lower end of the flexible elongate tendon 24 to secure the flexible elongate tendon 24 to the ground. An example of a suitable ground anchor is described in published U.K. Patent Application No. GB2514004.

The force applying arrangement 22 further includes a loop formation 26 at the opposite upper end of the flexible elongate tendon 24. In the embodiment shown, the loop formation 26 comprises a ring 27 attached to the end of the elongate tendon 24. The loop formation 26 is formed by passing the elongate tendon 24 through the ring 27. It will be appreciated that the loop formation 26 could be formed in any other suitable way known in the art.

In use, the loop formation 26 is arranged around the support post 20 in engagement with the first hook formation 14 at the lower end of the wound portion 12. When tension is applied to the force applying arrangement 22, the support post 100 is held in the position shown in FIG. 5.

FIG. 5 shows the support post 100 at an oblique angle. It will be appreciated that, if desired, the support post 100 could be vertical.

In use, the gripping arrangement 10 is disposed on the support post 100 so that the wound portion 12 extends around the support post 100 and the first hook formation 14 faces away from the flexible elongate tendon 24. The loop formation 26 is disposed around the support post 100, as described above, above the first hook formation 14, as shown in FIG. 6. The flexible elongate tendon 24 is arranged under tension as indicated by the arrow A in FIGS. 5 and 6.

If the loop formation 26 slips down the support post 100, it comes into engagement with the first hook formation 14, thereby pulling the first hook formation 14 downwardly in a first direction along the support post 100, as indicated by the arrow B in FIG. 6. This causes the wound portion 12 to extend lengthwise along the support post 100.

The extension of the wound portion 12 by the slipping of the loop formation 26 has the effect of causing the wound portion 12 to contract radially inwardly, i.e. in a direction transverse to the direction of extension of the wound portion 12. As a result of this contraction of the wound portion 12, the wound portion 12 is pulled tight against the support post 100, thereby gripping the support post 100.

The gripping of the support post 100 by the wound portion 12 inhibits further movement of the loop formation 26 down the support post 100.

The tension applying assembly 20 can be used to secure a vine support cable 102 to the support post 100, as shown in FIG. 7. The vine support cable 102 comprises a further loop formation 104.

The further loop formation 104 is arranged around the support post 100 and across the lower first hook formation 14 on a further gripping arrangement 10A. As the vine support cable 102 is pulled tight, as indicated by the arrow C in FIG. 7, the loop formation 104 is pulled on to the first hook formation 14, thereby pulling the first hook formation 14 downwardly. The wound portion 12 is thus caused to extend in the lengthwise direction of the support post 100 and to contract radially inwardly, thereby gripping the support post 100. As a result, the vine support cable 102 is held at the desired height on the support post 100.

There is thus described a gripping arrangement 10 and a tension applying assembly 20 which allows a force applying arrangement 22 to be secured to a main support and help prevent movement of the force applying arrangement downwardly along the support post 100. Further, the gripping arrangement 10 can be disposed on the support post 10 laterally, for example by winding the gripping arrangement 10 around the support post, and does not have to be pushed over the support post 100 from one end. Thus, the gripping arrangement 10 can be fitted to the support post 100 while it is in use.

Various modifications can be made without departing from the scope of the invention.

1-41. (canceled)

42. A gripping arrangement comprising a wound portion disposable around a main support, and a holding formation for holding a force applying arrangement, wherein a force applied to the holding formation in a first direction to extend the wound portion in said first direction can effect a contracting movement on the wound portion in a second direction transverse to the first direction.

43. A gripping arrangement according to claim 42, wherein a tension force applied by the force applying arrangement to the holding formation in said first direction can cause the wound portion to contract in said second direction and tighten around the main support, the second direction being a radially inward contraction.

44. A gripping arrangement according to claim 42, wherein the force applying arrangement is elongate.

45. A gripping arrangement according to claim 44, wherein the force applying arrangement comprises a loop formation, and wherein the loop formation can extend around the main support to engage the holding formation.

46. A gripping arrangement according to claim 42, wherein the wound portion comprises an elongate element and comprises a winding of greater than half a turn of the elongate element.

47. A gripping arrangement according to claim 46, wherein the wound portion comprises a winding of at least one turn of the elongate element.

48. A gripping arrangement according to claim 46, wherein the wound portion comprises a winding of substantially one and a half turns of the elongate element.

49. A gripping arrangement according to claim 42, comprising first and second holding formations, the first holding formation being provided at a first end of the wound portion, and the second holding formation being provided at a second opposite end of the wound portion.

50. A tension applying assembly for attaching to a main support, said assembly comprising a gripping arrangement and a force applying arrangement, the gripping arrangement comprising a wound portion disposable around the main support and a holding formation for holding the force applying arrangement, wherein a force applied to the holding formation in a first direction to extend the wound portion in said first direction effects a contracting movement on the wound portion in a second direction transverse to the first direction.

51. A tension applying assembly according to claim 50, wherein a tension force applied by the force applying arrangement to the holding formation in said first direction can cause the wound portion to contract in said second direction and tighten around the main support, the second direction being a radially inward contraction.

52. A tension applying assembly according to claim 50, wherein the force applying arrangement is elongate.

53. A tension applying assembly according to claim 51, wherein the force applying arrangement comprises a loop formation, and wherein the loop formation can extend around the main support to engage the holding formation.

54. A tension applying assembly according to claim 50, wherein the main support comprises a support post.

55. A tension applying assembly according to claim 50, wherein the wound portion comprises an elongate element and comprises a winding of greater than half a turn of the elongate element.

56. A tension applying assembly according to claim 55, wherein the wound portion comprises a winding of at least one turn of the elongate element.

57. A tension applying assembly according to claim 55, wherein the wound portion comprises a winding of substantially one and a half turns of the elongate element.

58. A tension applying assembly according to claim 50, comprising first and second holding formations, the first holding formation being provided at a first end of the wound portion, and the second holding formation being provided at a second opposite end of the wound portion.

59. A tension applying assembly according to claim 50, wherein the force applying arrangement includes an anchor arrangement for anchoring the force applying arrangement to the ground.

60. A method of using a tension applying assembly as claimed in claim 50, said method comprising disposing the gripping arrangement on a main support, arranging the force applying arrangement to extend around the main support, so that the force applying arrangement engages the holding formation, wherein method further includes securing the force applying arrangement to the ground to apply a force to the holding formation to cause the gripping arrangement to extend in a first direction lengthwise of the main support, and contract in a second direction transverse to the first direction to grip the main support.

61. A method according to claim 60, wherein a tension force is applied by the force applying arrangement to the holding formation in said first direction to cause the wound portion to contract in said second direction and tighten around the main support.
